(19) United States
(12) Patent Application Publication
(10) Pub. No.: US 2006/0187808 A1
(43) Pub. Date: Aug. 24, 2006

(54) Multi-layer information carrier with switching circuit

(76) Inventors: Josephus Arnoldus Henricus Kahlman, Eindhoven (NL); Martinus Bernardus Van Der Mark, Eindhoven (NL); Erwin Rinaldo Meinders, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/564,913

(22) PCT Filed: Jul. 8, 2004
(86) PCT No.: PCT/IB04/02321

§ 371 Date: Jan. 17, 2006

(30) Foreign Application Priority Data
Jul. 18, 2003 (EP) 03300068.8

(51) Int. Cl. G11B 7/24

(52) U.S. Cl. 369/275.1

(57) ABSTRACT

The invention relates to an information carrier comprising at least one information layer which optical properties depend on a potential difference applied between two electrodes (531,532). The information carrier is intended to be scanned by an optical scanning device comprising means for generating a signal comprising information about a selected information layer. The information carrier comprises means (51) for receiving this signal, means (521) for decoding this signal and means (522-524) for applying a potential difference between the electrodes corresponding to the selected information layer.

### FIELD OF THE INVENTION

The present invention relates to an information carrier comprising at least one information layer.

The present invention also relates to a system for scanning information.

The present invention is particularly relevant for optical data storage and optical disc apparatuses for reading and/or recording data from and/or on multi-layer optical discs.

### BACKGROUND OF THE INVENTION

In the field of optical recording, increasing the capacity of the information carrier is the trend. An already investigated way for increasing the data capacity consists in using a plurality of information layers in the information carrier. For example, a DVD (Digital Video Disc) can comprise two information layers. Information is recorded on or read from an information layer by means of an optical beam, using local refractive index variations or the presence of surface relief structures.

However, the number of information layers in such an information carrier is limited. First, because the light intensity of the optical beam decreases with each additional addressed layer. Actually, when the optical beam has to pass many layers for addressing a layer, interaction takes place in the non-addressed layers, reducing the intensity of the optical beam. Additionally, the local refractive index variations of the written information patterns in the non-addressed layers cause refraction and scattering of the traversing light-beam, leading to deteriorated writing and reading.

Hence, conventional optical data storage techniques are not suitable for multi-layer information carriers, in particular for information carriers comprising more than three layers.

### SUMMARY OF THE INVENTION

It is an object of the invention to provide an information carrier, which can comprise an increased number of layers.

To this end, the invention proposes an information carrier comprising at least one information layer which optical properties depend on a potential difference applied between two electrodes, said information carrier being intended to be scanned by an optical scanning device comprising means for generating a signal comprising information about a selected information layer, said information carrier comprising means for receiving said signal, means for decoding said signal and means for applying a potential difference between the electrodes corresponding to the selected information layer.

According to the invention, the optical properties of the information layers can be switched by applying a potential difference. Hence, by applying suitable potential differences, an optical beam can be used for scanning one layer having optical properties suitable for interacting with this optical beam, whereas the optical properties of the other layers are chosen so that the interactions between these non-addressed layers and the optical beam are reduced. As a consequence, the number of layers might be increased. As the information carrier rotate during scanning, it is not possible to apply potential differences to the information layers by means of wires connected to fixed parts of the optical scanning device. As a consequence, the information carrier comprises the means for applying potential differences. When an information layer is selected by the optical scanning device, in order to change its optical properties, generating means are used in the optical scanning device in order to generate a signal comprising information about the selected information layer. The information carrier comprises means for receiving said signal. Once the signal has been received, it is decoded in the information carrier and the information about the selected information layer is sent to applying means, which apply a potential difference between the electrodes corresponding to the selected information layer. As a consequence, no wire is used between the fixed parts of the optical scanning device and the information carrier, which allows the information carrier to rotate freely.

Moreover, as the information carrier comprises means for decoding the signal and means for switching the optical properties of the selected information layer, it is possible to add other functionalities in the information carrier, such as digital rights management. This will be explained in more details in the following. As a consequence, protection of content is an issue which can be solved by use of an information carrier and a system in accordance with the invention. Hence, the invention is also advantageous for an information carrier that comprises only one information layer.

Advantageously, the information carrier comprises an induction coil for cooperating with means for applying a magnetic flux, located in the optical scanning device, in order to create an inductive current, the means for applying a potential difference being adapted to apply a potential difference corresponding to said inductive current between said two electrodes. In this case, an induction coil mounted in the information carrier provides the energy necessary to apply potential differences. Hence, no battery is needed in the information carrier, as its rotation is converted into a current by means of the induction coil. Alternatively, a battery is used, and the induction coil is used in order to recharge said battery.

In a first embodiment of the invention, the receiving means comprise a photosensitive detector for receiving a radiation from a radiation source located in the optical scanning device.

In a second embodiment of the invention, the receiving means comprise an induction coil for cooperating with electromagnetic means, located in the optical scanning device, in order to create an inductive current inside said induction coil, said inductive current corresponding to said signal.

In a third embodiment of the invention, the receiving means comprise a primary conductor for cooperating with a secondary conductor located in the optical scanning device and adapted to transfer said signal to said first conductor by means of capacitive coupling.

In a fourth embodiment of the invention, the receiving means comprise a RF receiver for receiving a RF signal from a RF transmitter located in the optical scanning device.

In a fifth embodiment of the invention, the receiving means comprise at least one electrical contact adapted for connecting a connection of a rotating part of the optical scanning device. According to this embodiment, the signal comprising information about a selected information layer is first received in the rotating part of the optical scanning device, which comprise means for receiving said signal, such as a photosensitive detector, a conductor, an induction coil or a RF receiver, depending on the generating means used in the optical scanning device. This received signal is then sent to the information carrier via connections connected to electrical contacts of the information carrier. This simplifies the manufacturing process of the information carrier, which does not need any photosensitive detector, conductor, induction coil or RF receiver. Moreover, this makes the information carrier compatible with an optical scanning device, whatever the generating means used in this optical scanning device.

The invention also relates to a system comprising an information carrier as described hereinbefore and an optical scanning device comprising a rotating part comprising means for receiving said information carrier and a fixed part comprising means for generating a signal comprising information about a selected information layer.

Preferably, the rotating part comprises means for receiving said signal and sending said signal to a connection adapted for connecting an electrical contact of said information carrier.

These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIG. 1a and 1b show a first ROM information carrier in accordance with the invention;

FIG. 2 shows a second ROM information carrier in accordance with the invention;

FIG. 3 shows a WORM information carrier in accordance with the invention;

FIG. 4 shows a RW information carrier in accordance with the invention;

FIG. 5 shows an information carrier in accordance with the invention;

FIG. 6 is a block diagram showing a functioning of the information carrier of FIG. 5;

FIG. 7 shows an information carrier in accordance with an advantageous embodiment of the invention;.

FIG. 8 shows an information carrier in accordance with a first embodiment of the invention;

FIG. 9 shows an information carrier in accordance with a second embodiment of the invention;

FIG. 10 shows an information carrier in accordance with a third embodiment of the invention;

FIG. 11 shows an information carrier in accordance with a fourth embodiment of the invention;

FIG. 12 shows an information carrier in accordance with a fifth embodiment of the invention.

### DETAILED DESCRIPTION OF THE INVENTION

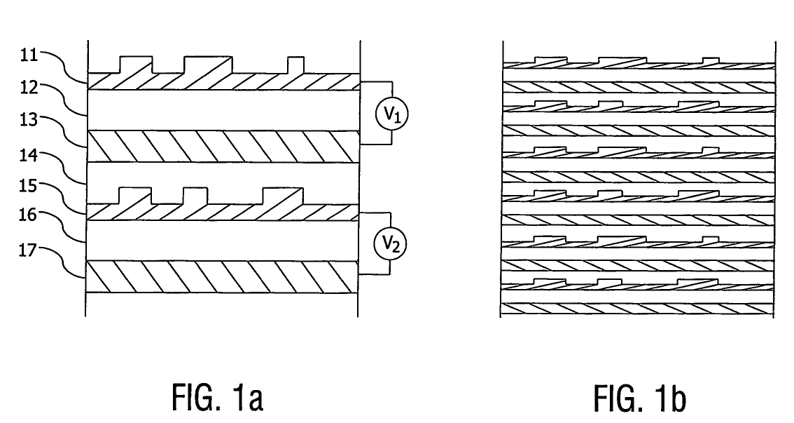

A first ROM information carrier in accordance with the invention is depicted in FIG. 1a. Such an information carrier comprises a first information layer 11, a first electrolyte layer 12, a first counter electrode 13, a spacer layer 14, a second information layer 15, a second electrolyte layer 16 and a second counter electrode 17. Such an information carrier might comprise more than two information layers. For example, such an information carrier might comprise 10, 20 or up to 100 or more information layers. For example, an information carrier comprising 6 information layers is depicted in FIG. 1b. Such an information carrier might comprise information layers which optical properties cannot be changed by means of a potential difference. For example, the information carrier can comprise a ROM, a WORM or a RW information layer with non-switchable optical properties, said information layer being used as last information layer in the information carrier. This is particularly useful in an information carrier implementing the BD standard (BD stands for Blu-Ray Disc).

The information layers 11 and 15 comprise pits and lands, which are obtained by means of conventional techniques, such as embossing and printing.

This information carrier is intended to be scanned by an optical beam, which has a wavelength 1. The first and second electrolyte layers 12 and 16, the first and second counter electrodes 13 and 17 as well as the spacer layer 14, are chosen to be transparent at the wavelength 1, or at least to have a very small absorption at this wavelength, in order not to interact with the optical beam.

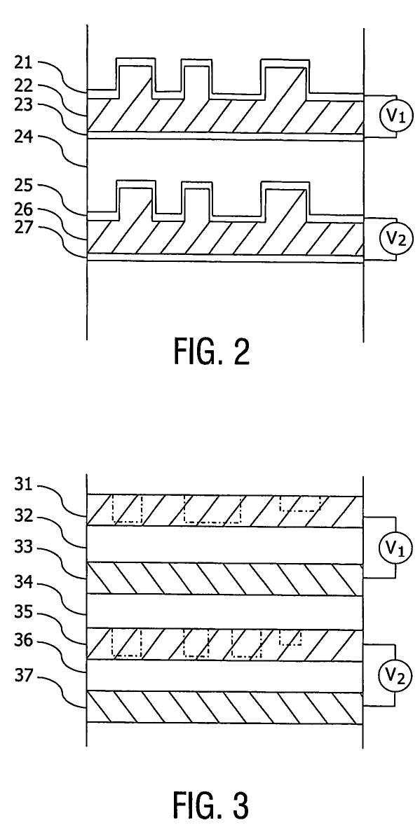

In the example of FIGS. 1a and 1b, the first and second information layers 11 and 15 comprise an electrochromic material. Other materials can be used in the information stacks, which optical properties can be switched by means of a potential difference. Another example is depicted in FIG. 2.

An electrochromic material is a material having optical properties, which can change as a result of electron uptake or loss. Electrochromic materials are known from those skilled in the art. For example, the publication “Electrochromism: Fundamentals and Applications”, written by Paul M. S. Monk et. al. and published in 1995, describes the properties of electrochromic materials. Preferably, the electrochromic materials used in such an information carrier are thiophene derivatives, such as poly(3,4-ethylenedioxythiophene), also called PEDT or PEDOT and described, for example, in “Poly(3,4-ethylenedioxythiophene) and Its Derivatives: Past, Present and Future”, by L. Bert Goenendaal et. al., published in Advanced Materials 2000, 12, No. 7.

In the example of FIG. 1a, the electrochromic material of the first and second information layers 11 and 15 is the same, and has a reduced state and an oxidized state. The electrochromic material is chosen to have a high absorption and reflection at the wavelength 1 when it is in its reduced state, and a low absorption and reflection at the wavelength 1 when it is in its oxidized state.

When the first information layer 11 is scanned for reading information from this first information layer 11, a potential difference V1 is applied between the first information layer 11 and the first counter electrode 13, the first information layer 11 being at a higher potential than the first counter electrode 13. A current flows from the first information layer 11 to the first counter electrode 13, whereas electrons are transported from the first counter electrode 13 to the first information layer 11. Electrons are absorbed by the electrochromic material, which becomes reduced. For reasons of electrical neutrality, positive ions from the first electrolyte layer 12 are absorbed by the first information layer 11 or negative ions are expelled by the first information layer 11, and negative ions from the first electrolyte 12 are absorbed by the first counter electrode 13 or positive ions are expelled by the first counter electrode 13. Hence, the first counter electrode is an ion-accepting and donating electrode. The potential difference V1 is chosen so that, when applied, the absorption and reflection of the first information layer 11 becomes relatively high at the wavelength 1.

Then, once the absorption and reflection of the first information layer 11 are high, information can be read from this information layer using conventional read-out techniques, such as the phase difference read-out principle used, for example, for read-out of CD-ROM, or alternatively by the reflection or absorption difference between marks and non-marks.

Once the information of the first information layer 11 has been read, the second information layer 15 is scanned. First, the first information layer 11 is made transparent by applying a potential difference −V1 between the first information layer 11 and the first counter electrode 13, which is a reverse potential difference compared to V1. As a consequence, the electrochromic material of the first information layer 11 becomes oxidized, in which state it has a low absorption and reflection at the wavelength 1. Then, the second information layer 15 is made absorbent, by applying a potential difference V2 between the second information layer 15 and the second counter electrode 17. In this example, V2 is equal to V1, because the first and second information stacks comprise the same electrochromic material.

Once the absorption and reflection of the second information layer 15 are high, information can be read from this information layer. The first information layer 11 does not perturb read-out of information, because the first information layer 11 is made transparent. As a consequence, it is possible to address only one information layer, while the rest of the information carrier is transparent or has a low absorption and reflection. The desired layer is addressed by applying the suitable potential differences between the information layers and the counter electrodes of the different information stacks.

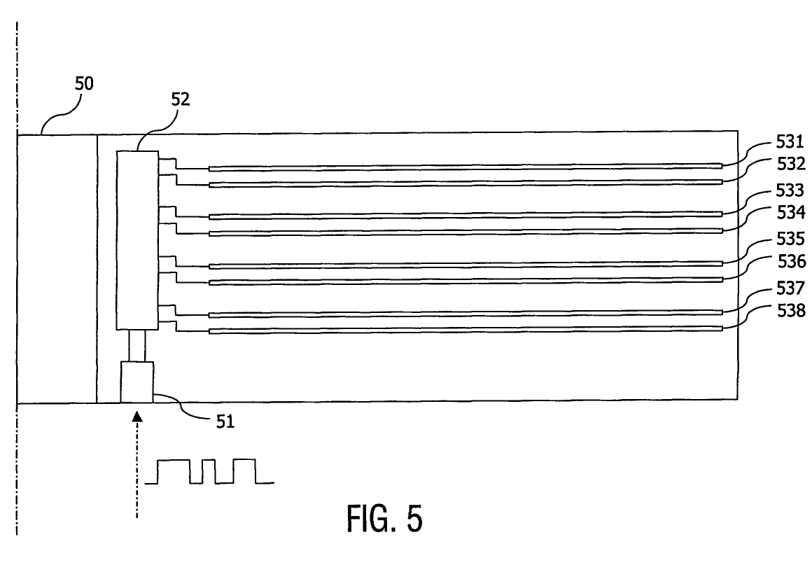

The information layers thus have optical properties, which depend on a potential difference applied between two electrodes. In the case of FIGS. 1a and 1b, the two electrodes are the information layer and the counter electrode. In other cases, an information layer can be placed between two electrodes. As a consequence, potential differences have to be applied to such an information carrier. FIG. 5 to 12 describe how a potential difference is applied to a selected information layer, in an information carrier in accordance with the invention.

A second ROM information carrier in accordance with the invention is depicted in FIG. 2. Such an information carrier comprises a first, a second, a third and a fourth electrode 21, 23, 25 and 27, a first and a second information layer 22 and 26 and a spacer layer 24. The first electrode 21, the first information layer 22 and the second electrode 23 form a first information stack, the third electrode 25, the second information layer 26 and the fourth electrode 27 form a second information stack. The two information stacks are separated by the spacer layer 24.

An information layer of an information stack comprises molecules which can be rotated with respect to their initial orientation when a suitable potential difference is applied between the electrodes of said information stack. Molecules having an ability to turn towards a given direction when a potential difference is applied between electrodes are, for example, liquid crystal molecules. Such liquid crystal molecules are described, for example, in “Handbook of Liquid Crystal Research”, written by Peter J. Collings, Jay S. Patel, Oxford University Press, New York, 1997. For example, when a suitable potential difference is applied between the first and second electrodes 21 and 23, an electric field is created, which electric field has a direction substantially orthogonal to the first and second electrodes 21 and 23. When subjected to this electric field, the liquid crystal molecules of the first information layer 22 turn towards the direction of the electric field.

When no potential difference is applied between the first and second electrodes 21 and 23, the liquid crystal molecules of the first information layer 22 are randomly directed, so that the first information layer 22 is substantially transparent at the wavelength 1. When a suitable potential difference is applied between the first and second electrodes 21 and 23, the liquid crystal molecules of the first information layer 22 turn towards the direction of the electric field created by said potential difference, which results in the first information layer 22 becoming absorbent and reflective at the wavelength 1. This is a consequence of a change in index of refraction, which results from the re-orientation of the liquid crystal molecules of the first information layer 22.

The molecules used in this second ROM information carrier can also be molecules comprising a charged substituent which turn towards the direction of a current created by the potential difference applied between two electrodes. Examples of such molecules are ionomers or polyelectrolytes. Polyelectrolytes or ionomers consist of ion-containing polymers, consisting of polymeric backbones with a relatively small number of monomer units with an ionic functionality either as a pendant group or incorporated in the main chain. Mostly, structures with carboxylic, sulfonic, or phosphoric acids can be used, which are partially or fully neutralized with cations. These materials are described in, for instance, “Ionic Polymers”, by L. Holliday, Applied Science Publishers, London, 1975. Particular examples of these materials are for instance poly(2-acrylamido-2-methylpropanesulphonic acid), poly(ethylene sulphonic acid), poly(styrene sulphonic acid), and zinc or sodium salts of copolymers such as poly(ethylene-co-methyl acrylic acid).

When the first information layer 22 is selected for reading information from this first information layer 22, a potential difference V1 is applied between the first and second electrodes 21 and 23. An electric field is thus created between the first and second electrodes 21 and 23. Thus, the liquid crystal molecules of the first information layer 22 turn towards the direction of this electric field, i.e. a direction substantially orthogonal to the first and second electrodes 21 and 23. As a consequence, the first information layer 22 becomes absorbent and reflective at the wavelength 1.

The potential difference V1 is chosen so that, when applied, the absorption and reflection of the first information layer 22 become relatively high at the wavelength 1. The potential difference V1 depends on the wavelength 1, the chemical structure of the liquid crystal molecules, the layer thickness of the first information layer 22 and the first and second electrodes 21 and 23. Examples of material which can be used for the first and second electrodes 21 and 23 are ITO (Indium Tin Oxide), PEDOT (poly(3,4-ethylenedioxythiophene)) or PPV (poly(phenylenevinylene)).

Then, once the absorption and reflection of the first information layer 22 are high, information can be read from this information layer using conventional read-out techniques.

Once the information of the first information layer 22 has been read, the second information layer 26 is scanned. First, the first information layer 22 is made transparent by removing the potential difference V1. The electric field between the first and second electrodes 21 and 23 disappears, the liquid crystal molecules rotate back to their initial orientation and the first information layer 22 thus becomes transparent.

Then, the second information layer 26 is made absorbent and reflective, by applying a potential difference V2 between the third and fourth electrode 25 and 27. In this example, V2 is equal to V1, because the first and second information stacks comprise the same liquid crystal molecules. If different molecules having an ability to turn towards a given direction are used in the first and second information layers 22 and 26, V2 might differ from V1. Also if the layer thickness of the information layers 22 and 26 is different, a different potential difference might be needed.

Once the second information layer 26 is absorbent and reflective, information can be read from this second information layer 26. The first information layer 22 does not perturb read-out of information, because the first information layer 22 is made transparent. As a consequence, it is possible to address only one information layer, while the rest of the information carrier is substantially transparent. The desired layer is addressed by applying the suitable potential differences between the electrodes of the different information stacks.

FIG. 3 shows a WORM (Write Once Read Many) information carrier in accordance with the invention. This information carrier comprises a first information layer 31, a first electrolyte layer 32, a first counter electrode 33, a spacer layer 34 a second information layer 35, a second electrolyte layer 36 and a second counter electrode 37. The first information layer 31, the first electrolyte layer 32 and the first counter electrode 33 form a first information stack, the second information layer 35, the second electrolyte layer 36 and the second counter electrode 37 form a second information stack. The two information stacks are separated by the spacer layer 34.

The first and second information layers 31 and 35 comprise an electrochromic material having an ability to take up or release electrons, which can be locally reduced by means of the optical beam at the wavelength 1. In order to locally reduce the ability to take up or release electrons of the electrochromic materials, a relatively high power of the optical beam is required. The high power is absorbed in the material and changes its material properties, for example by melting, annealing, photochemical reactions, thermal damaging or deterioration. This relatively high power is used during writing of information on the information carrier, whereas a smaller power is used during reading, the latter being not able to reduce the ability to take up or release electrons of the electrochromic materials.

In order to write information on the first information layer 31, the optical beam having the relatively high power is focussed on the first information layer 31, in order to locally reduce the ability to take up or release electrons of the electrochromic material, for writing marks. In FIG. 3, the marks where the ability to take up or release electrons of the electrochromic material is reduced are represented by dotted lines. The depth of the marks in the information layers can be chosen by varying the power of the optical beam, or by varying the time during which the optical beam is focussed on a mark. Having different depth of marks allows multilevel recording. In single-level recording, typically two reflection states or levels are used, whereas in case of multi-level recording, more reflection levels are defined to represent data.

In order to write information on the second information layer 35, the optical beam having the relatively high power is focussed on the second information layer 35, in order to locally reduce the ability to take up or release electrons of the electrochromic material, for writing marks.

The information layer on which information has to be written might be made absorbent before focussing the relatively high power optical beam on it. This improves absorption of the relatively high power optical beam, which increases the reduction of the ability to take up or release electrons of the electrochromic material.

In order to read information from the first information layer 31, this first information layer 31 is made absorbent and reflective at the wavelength 1, by applying a suitable voltage V1 between the first information layer 31 and the first counter electrode 33. The first information layer 31 becomes absorbent and reflective, except where marks have been written, because the ability to take up or release electrons of these marks is too small for allowing a reduction of the electrochromic material of these marks. Hence, the difference in absorption and reflection between the marks and the non-marked areas in the first information layer 31 is used for reading information from the first information layer 31.

In order to read information from the second information layer 35, the first information layer 31 is made transparent at the wavelength 1, by applying a reverse voltage −V1 between the first information layer 31 and the first counter electrode 33. Hence, the whole first information layer 31, including the marks, becomes transparent. Hence, the first information layer 31 does not perturb the scanning of the second information layer 35. Then, the second information layer 35 is made absorbent and reflective at the wavelength 1, by applying a suitable voltage V2, equal to V1 if the electrochromic materials of the first and second information layers 31 and 35 are the same, between the second information layer 35 and the second counter electrode 37. The second information layer 35 becomes absorbent and reflective, except where marks have been written. Information can then be read from the second information layer 35.

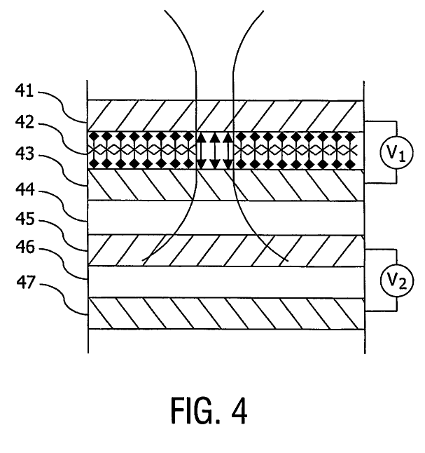

FIG. 4 shows a RW (ReWritable) information carrier in accordance with the invention. This information carrier comprises a first information layer 41, a first electrolyte layer 42, a first counter electrode 43, a spacer layer 44 a second information layer 45, a second electrolyte layer 46 and a second counter electrode 47. The first information layer 41, the first electrolyte layer 42 and the first counter electrode 43 form a first information stack, the second information layer 45, the second electrolyte layer 46 and the second counter electrode 47 form a second information stack. The two information stacks are separated by the spacer layer 44.

The first and second electrolyte layers 42 and 46 have a temperature-dependent mobility threshold. This means that, under this threshold, the mobility of ions within these electrolyte layers is low, whereas the ions-mobility is high above this threshold. Examples of such electrolyte layers are a polymeric matrix having a suitable glass transition, non-covalently bonded aggregates that show a suitable temperature dependent equilibrium between an aggregated and a free form, or a polymeric matrix having a relatively strong temperature-dependent viscosity.

In order to write a mark on the first information layer 41, the optical beam is focussed on this mark. The electrolyte layer under this mark is heated, and the temperature of the electrolyte layer under this mark exceeds the mobility threshold. A suitable potential difference V1 is applied between the first information layer 41 and the first counter electrode 43. As the ions-mobility is low where the optical beam is not focussed, the electrochromic process takes place only where the ions-mobility is high, i.e. where a mark is to be written. As a consequence, the first information layer 41 becomes absorbent and reflective only where the optical beam is focussed, and a mark is written where this optical beam is focussed. Then, in order to write another mark on the first information layer 41, the optical beam is focussed at the place where this other mark has to be written. Then, when the potential difference V1 is cut, the written marks remain absorbent and reflective, because of the bistability of the electrochromic material. The same process is repeated in order to write marks on the second information layer 45.

The electrolyte layers are chosen so as to have a decomposition temperature, which is lower than the temperature-dependent mobility threshold. In that case, the information layers are not degraded during writing, which means that the writing process is reversible.

In order to read information from the first information layer 41, the optical beam is focussed on this information layer, and the difference of absorption and reflection between the marks and the non-marked area is used for read-out. No difference potential is needed between the first information layer 41 and the first counter electrode 43, as the marks remain absorbent and reflective without applied potential difference. The same process is repeated in order to read information from the second information layer 45.

The information written on the information layers of this information carrier can be erased, and information can be rewritten on these information layers. In order to erase information written on the first information layer 41, this first information layer 41 is scanned by a relatively high power optical beam. The first electrolyte layer 42 is heated, and the temperature of the first electrolyte layer 42 exceeds the mobility threshold. A potential difference −V1 is applied between the first information layer 41 and the first counter electrode 43. As a consequence, the written marks become oxidized and hence transparent. The whole first information layer 41 thus becomes transparent, and marks can then be rewritten on this first information layer 41, as described above. The same process is repeated in order to erase information written on the second information layer 45.

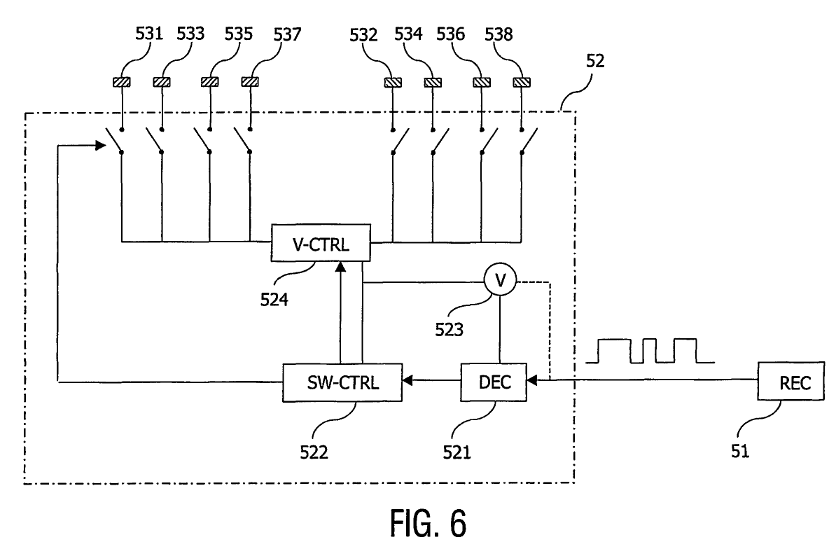

FIG. 5 shows an information carrier in accordance with the invention. This information carrier comprises a central hole 50, receiving means 51, addressing means 52, and eight electrodes 531 to 538. The addressing means 52 comprise decoding means and applying means, as will be described in details in FIG. 6. Only one half of the information carrier is represented in FIG. 5. This information carrier is intended to be scanned by an optical scanning device. For example, the information carrier is mounted on a damper of an optical scanning device, by means of the central hole 50.

In the examples described hereinafter, the information carrier comprises four information layers. A first information layer is located between electrodes 531 and 532, a second information layer between electrodes 533 and 534, a third information layer between electrodes 535 and 536 and a fourth information layer between electrodes 537 and 538.

The receiving means 51 are adapted to receive a signal comprising information about a selected information layer, which optical properties have to be changed. For example, an identifier of the selected information layer is encoded in this signal. Instead of an identifier of the selected information layer, the signal can comprise identifiers of the electrodes between which a potential difference has to be applied. This is equivalent, as an identifier of the selected information layer can be deduced from identifiers of the electrodes between which a potential difference has to be applied. The signal might comprise further information, such as an amplitude of a potential difference that has to be applied between two electrodes in order to change the optical properties of the selected information layer.

This signal is, for example, a modulated signal, which is modulated as a function of the information about the selected information layer. Various types of modulation can be used, such as pulse modulation, analogue or digital frequency modulation, amplitude modulation or phase modulation.

The received signal is provided to the addressing means 52, which are adapted to apply a potential difference between two electrodes in order to change the optical properties of the information layer corresponding to the information comprised in the signal.

The addressing means 52 are depicted in details in FIG. 6. The addressing means 52 comprise decoding means 521, switch controlling means 522, an energy source 523 and voltage controlling means 524. The addressing means 52 further comprise switches, each switch corresponding to a given electrode 531 to 538. The switch controlling means 522, the energy source 523, the voltage controlling means 524 and the switches form applying means. The decoding means 521, the switch controlling means 522 and the voltage controlling means 524 are powered by the energy source 523.

The signal comprising information about the selected information layer is received by the receiving means 51. The received signal is then decoded by the decoding means 521, which then provides an identifier corresponding to the selected information layer. The decoding means 521 might provide further information, such as an amplitude of the potential difference, which has to be applied between two contacts. On the basis of this identifier, the switch controlling means 522 control the switches, so that a potential difference is applied between the electrodes corresponding to the selected information layer. For example, if we assume that the selected information layer is the first information layer, the switch controlling means 522 switch on the switches corresponding to the electrodes 531 and 532. A potential difference is then applied between electrodes 531 and 532, so that the optical properties of the corresponding information layer are changed.

The potential difference applied between two electrodes is controlled by the voltage controlling means 524. Actually, as it has been described hereinbefore, different potential differences have to be applied, depending on the desired change of optical properties. For example, it might be necessary to apply a positive potential difference to an information layer in order to make it absorbent and reflective, and a negative potential difference in order to make it transparent.

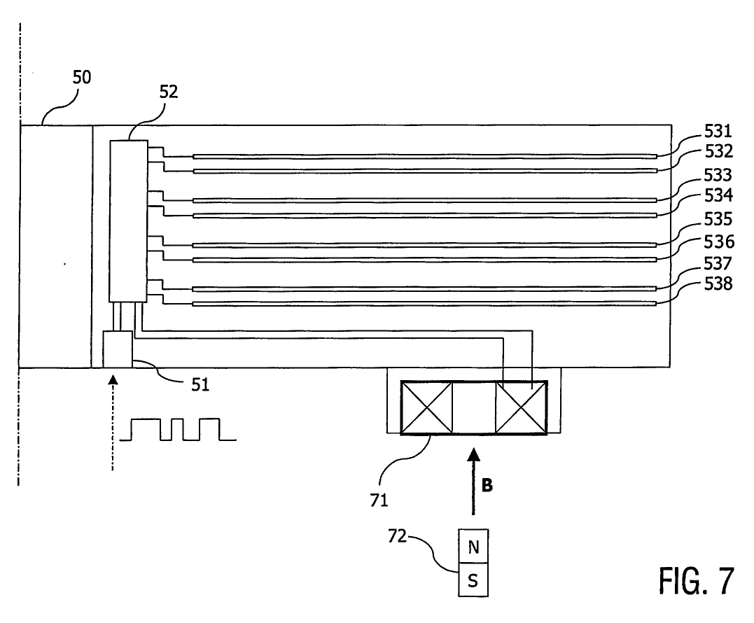

The energy source 523 can be a battery. This battery might be rechargeable, for example by means of a photodiode illuminated by the radiation source used for scanning the information carrier, or by any other light source such as an additional LED (LED stands for Light Emitting Diode) mounted in the optical scanning device, or by means of an induction coil mounted on the information carrier, as depicted in FIG. 7.

Alternatively, the applying means can be adapted to apply a potential difference corresponding to the received signal between the electrodes. In this case, the energy source 523 is a power converter, such as a rectifier. A part of the received signal is decoded by the decoding means 521, another part is sent to the energy source 523, which converts this signal into a suitable voltage and current.

The energy source 523 might also be a combination of a rechargeable battery and a power converter. In this case, a part of the received signal is converted into power, which is used for recharging the battery.

FIG. 7 shows an information carrier in accordance with an advantageous embodiment of the invention, with an induction coil mounted on said information carrier. The information carrier comprises an induction coil 71 mounted on it. The optical scanning device further comprises a fixed magnet 72, which creates a magnetic field B. During scanning of the information carrier, the information carrier rotates. As a consequence, the magnetic flux created by the magnetic field inside the induction coil 71 varies, so that an inductive current is created in the induction coil 71. This inductive current is used by the addressing means 52, which supplies said inductive current between the two electrodes corresponding to the selected information layer. In this case, no battery is needed. Alternatively, a battery can be used in the information carrier, and the inductive current is then used in order to recharge said battery.

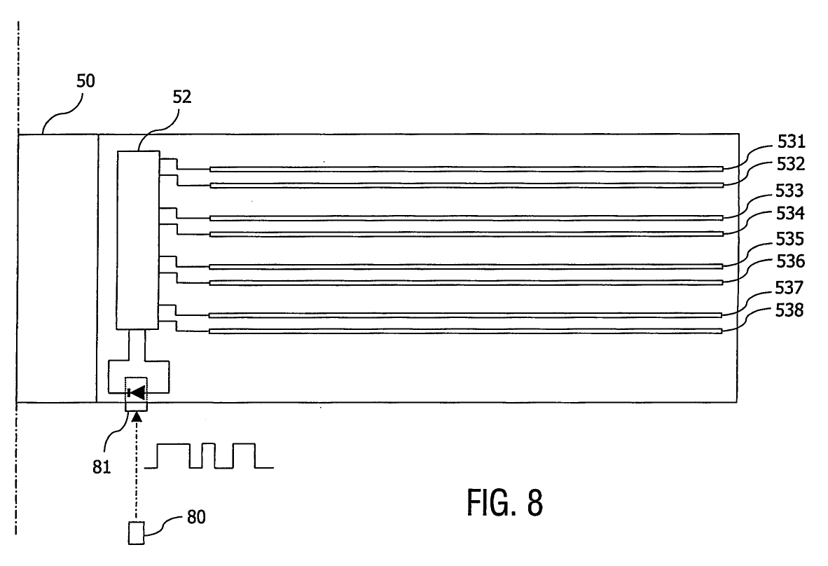

FIG. 8 shows an information carrier in accordance with a first embodiment of the invention. In this embodiment, the receiving means comprise a photosensitive detector 81. The photosensitive detector is adapted for receiving a signal generated by a radiation source 80 located in the optical scanning device. The radiation source 80 is, for example, a laser or a LED. The radiation source 80 might be the radiation source that is used for scanning the information carrier.

The radiation source 80 generates a radiation comprising information about a selected information layer, for example a pulse modulated radiation. The photosensitive detector 81 receives this radiation and converts this radiation into a signal, which is sent to the addressing means 52.

In the example of FIG. 8, the photosensitive detector 81 is not permanently illuminated by the radiation source 80. Actually, the photosensitive detector 81 has a certain area, and is located on the information carrier, so that it rotates during scanning of the information carrier. If it is assumed that the photosensitive detector 81 has a diameter of 1 millimetre, it is then illuminated during about 0.1 milliseconds per rotation of the information carrier, if the information carrier rotates with a linear velocity of 10 meter per second, which corresponds to the linear velocities usually used in the conventional optical scanning devices, such as a CD (Compact Disc), a DVD or a BD (Blu-Ray Disc) player. During this time of 0.1 milliseconds, the photosensitive detector 81 has to receive the information about the selected information layer. If the information carrier comprises 100 information layers, less than 100 pulses are necessary to encode the information about these information layers. Hence, pulses of microseconds length can be used. This can easily be achieved with a conventional LED or laser used as radiation source 80.

FIG. 9 shows an information carrier in accordance with a second embodiment of the invention. In this embodiment, the information carrier comprises an induction coil 93, which is adapted for cooperating with electromagnetic means 92 located in the optical scanning device. The information carrier is mounted on a damper 90, which is mounted on a rotation axis 94, which is connected to a spinning motor.

The electromagnetic means 92 are connected to a generator 91. The electromagnetic means 92 and the generator 91 form generating means, which are fixed in the optical scanning device. The generator 91 generates a signal comprising information about the selected information layer. For example, a modulated signal is generated. The electromagnetic means 92 converts this signal into a modulated magnetic field. As a consequence, an inductive current is created in the induction coil 93, which inductive current is modulated and corresponds to the modulated signal generated by the generator 91. Hence, the induction coil 93 is adapted to receive the signal generated by the generator 91. The received signal is then transmitted to the addressing means 52. In this embodiment, the rotation of the induction coil 93 does not play any role, as the inductive current is created by the variation of the magnetic flux inside the induction coil 93, which variation is due to the modulated magnetic field. As a consequence, the received signal does not depend on the speed of rotation of the rotating part, which is an advantage.

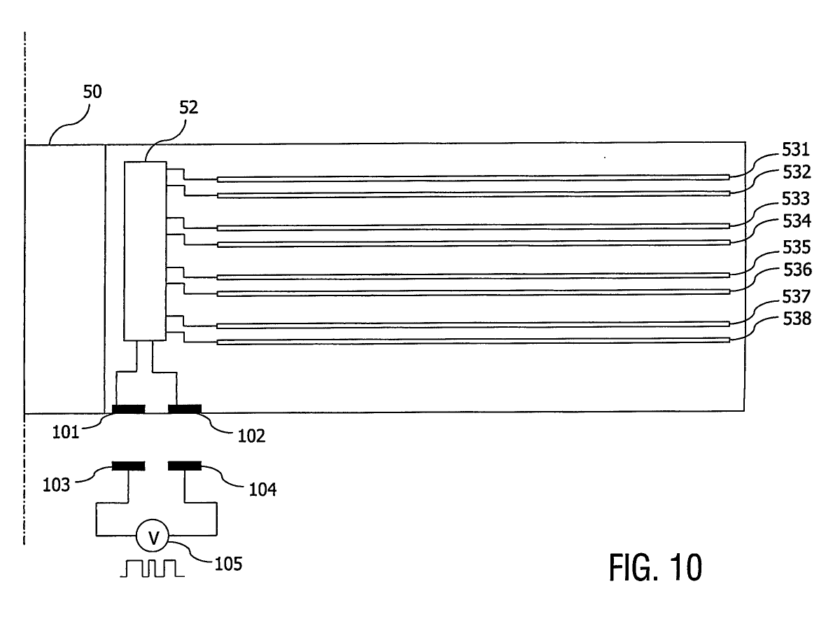

FIG. 10 shows an information carrier in accordance with a third embodiment of the invention. In this embodiment, the information carrier comprises a first primary conductor 101 and a second primary conductor 102. The first and second primary conductors 101 and 102 are for example parts of concentric rings. The first and second primary conductors 101 and 102 are adapted to cooperate with a first and a second secondary conductors 103 and 104, located in the optical scanning device. The first and second secondary conductors 103 and 104 are also for example parts of concentric rings, for example half a ring, depending on the available room in the optical scanning device. The first and second secondary conductors 103 and 104 are connected to a generator 105, adapted for generating a modulated signal.

When an information layer is selected, the generator 105 generates a signal comprising information about the selected information layer. This signal is applied between the first and second secondary conductors 103 and 104, which are arranged in such a way that a capacitive coupling occurs between the first primary conductor 101 and the first secondary conductor 103, and between the second primary conductor 102 and the second secondary conductor 104. As a consequence, the signal is applied between the first and second primary conductors 101 and 102. The received signal is then sent to the addressing means 52.

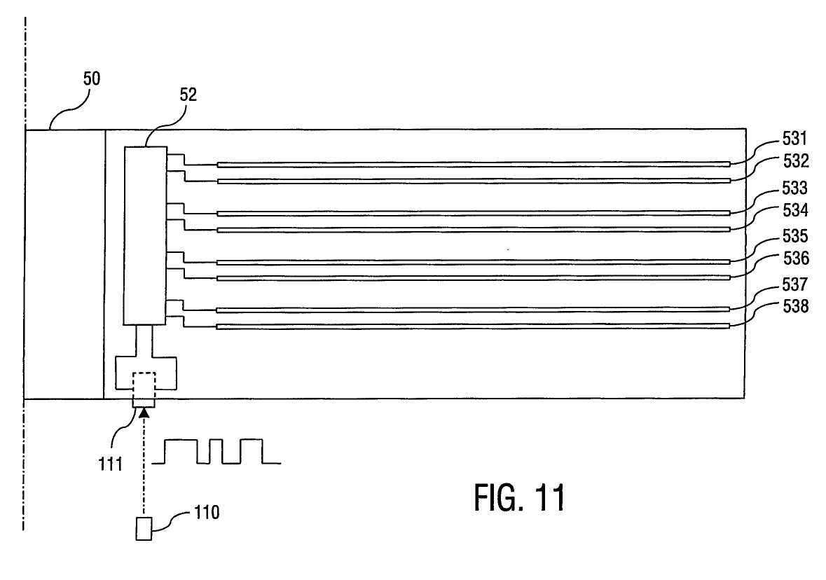

FIG. 11 shows an information carrier in accordance with a fourth embodiment of the invention. In this embodiment, the information carrier comprises a RF (Radio Frequency) receiver 111 for receiving a RF signal from a RF transmitter 110 located in the optical scanning device. When an information layer is selected, the RF transmitter 110 generates and transmits a RF signal comprising information about said selected information layer. This signal is received by the RF receiver 111, which preferably comprises an antenna, such as a circular antenna. The received signal is then sent to the addressing means 52.

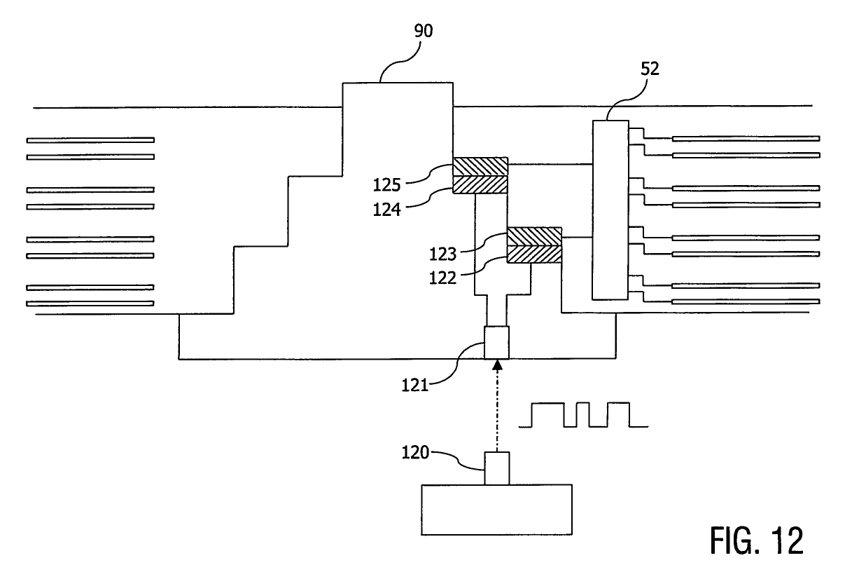

FIG. 12 shows an information carrier in accordance with a fifth embodiment of the invention. In this embodiment, the receiving means of the information carrier comprise a first electrical contact 123 and a second electrical contact 125. The optical scanning device comprises a damper 90, which rotates during scanning and is adapted to receive the information carrier. The damper 90 comprises a first connection 122 and a second connection 124. When the information carrier is mounted on the damper 90, the first electrical contact 123 is connected to the first connection 122 and the second electrical contact 125 is connected to the second connection 124.

The optical scanning device comprises means 120 for generating a signal comprising information about a selected information layer. The damper 90 further comprises means 121 for receiving said signal. For example, the generating means 120 comprise a radiation source and the receiving means 121 comprise a photosensitive detector. Other examples are possible, such as a RF transmitter and a RF receiver. The receiving means 121 are connected to the first and second connections 122 and 124. Hence, the received signal is applied between the first and second electrical contacts 123 and 125, which are electrically connected to the first and second connections 122 and 124, respectively. The first and second electrical contacts 123 and 125 are connected to the addressing means 52, which apply a potential difference between the electrodes corresponding to the selected information layer.

Such an information carrier requires only one or two galvanic contacts with the damper 90. Hence, the area of these electrical contacts can be relatively large, so that the functioning of the system represented on FIG. 12 is not affected by bad contacting due to dust or mechanical tolerances.

It should be noticed that the addressing means 52 in an information carrier in accordance with the invention might comprise other functionalities. The addressing means 52 can for example be a part of a Digital Rights Management (DRM) architecture. This allows protecting the data on the information carrier for unwanted read-out, deletion or overwrite.

A way of achieving such a content protection is to protect the signal comprising information about a selected information layer by means of a key which can only be decoded in the addressing means 52. Actually, as it has been explained hereinbefore, the optical properties of the information layer have to be switched in order to read from or record to these information layers. If the signal comprising information about a selected information layer cannot be decoded, the information carrier cannot be read or written properly.

The addressing means 52 are programmed in such a way that decoding the signal comprising information about a selected information layer requires the presence of a unique key or password in that signal. This key is for example distributed to the user separately from the information carrier. If the user wishes to scan the information carrier, he provides this key to the optical scanning device. If an unauthorized user wishes to scan this information carrier, but does not have the key, he will not be able to provide the key to the optical scanning device, and, as a consequence, the addressing means 52 will not be able to decode said signal. Alternatively, the key or password might be present in the optical scanning device. In this case, if the information carrier is scanned by an optical scanning device that does not have said key, the scanning is not possible.

An example of such a content protection for an information carrier comprising only one layer is given hereinafter. When a user buys such an information carrier, the information layer is transparent and cannot be scanned. Hence, the optical properties of this information layer have to be switched in order to enable scanning. If the user does not have the required key, the optical properties cannot be switched and the information carrier can thus not be scanned.

This also applies to a multi-layer information carrier. For example, all the information layers can be made transparent, or all the information layers can be made absorbent or reflective, so that scanning of most of the layers is not possible. If the user does not have the required key, the optical properties of the information layers cannot be switched.

Another way of achieving such a content protection, which is more secure, consists in encoding the data and putting the encoded data on different information layers, so that the information layers have to be addressed in a predefined order in order to achieve a proper scanning of the information carrier. Only a key allows for decoding said data by addressing the information layers in the right order. This key is for example distributed to the user separately from the information carrier. The user provides this key to the optical scanning device, which sends the key to the addressing means 52.

By implementing a bi-directional communication channel between the optical scanning device and the information carrier, more sophisticated security schemes e.g. using a Secure Authenticated Channel (SAC) are possible. For example, the data on the information carrier are scrambled, and only a descrambling key allows for decoding said data in the optical scanning device. This descrambling key is sent by the addressing means 52 to the optical scanning device, for example by means of a RF transmitter embedded in the addressing means 52.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An information carrier comprising at least one information layer which optical properties depend on a potential difference applied between two electrodes (531, 532), said information carrier being intended to be scanned by an optical scanning device comprising means for generating a signal comprising information about a selected information layer, said information carrier comprising means (51) for receiving said signal, means (521) for decoding said signal and means (522-524) for applying a potential difference between the electrodes corresponding to the selected information layer.

2. An information carrier as claimed in claim 1, wherein the means for applying a potential difference comprise a battery (523).

3. An information carrier as claimed in claim 1, further comprising an induction coil (71) for cooperating with means (72) for applying a magnetic flux, located in the optical scanning device, in order to create an inductive current, the means for applying a potential difference being adapted to apply a potential difference corresponding to said inductive current between said two electrodes.

4. An information carrier as claimed in claim 1, wherein the receiving means comprise a photosensitive detector (81) for receiving a radiation from a radiation source (80) located in the optical scanning device.

5. An information carrier as claimed in claim 1, wherein the receiving means comprise an induction coil (93) for cooperating with electromagnetic means (92), located in the optical scanning device, in order to create an inductive current inside said induction coil, said inductive current corresponding to said signal.

6. An information carrier as claimed in claim 1, wherein the receiving means comprise a primary conductor (101) for cooperating with a secondary conductor (103) located in the optical scanning device and adapted to transfer said signal to said first conductor by means of capacitive coupling.

7. An information carrier as claimed in claim 1, wherein the receiving means comprise a RF receiver (111) for receiving a RF signal from a RF transmitter (110) located in the optical scanning device.

8. An information carrier as claimed in claim 1, wherein the receiving means comprise at least one electrical contact (123) adapted for connecting a connection (122) of a rotating part (90) of the optical scanning device.

9. An information carrier as claimed in claim 1, wherein the means for decoding the signal comprising information about a selected information layer require the presence of a unique key or password in said signal.

10. A system for scanning information, said system comprising an information carrier as claimed in claim 1 and an optical scanning device comprising a rotating part comprising means for receiving said information carrier and a fixed part comprising means for generating a signal comprising information about a selected information layer.

11. A system as claimed in claim 9, wherein said rotating part comprises means for receiving said signal and sending said signal to a connection adapted for connecting an electrical contact of said information carrier.

12. A system as claimed in claim 9, wherein the means for decoding the signal comprising information about a selected information layer require the presence of a unique key or password in said signal and the generating means are adapted to generate a signal comprising said key or password.
